(19) United States
(12) Patent Application Publication
(10) Pub. No.: US 2004/0015549 A1
(43) Pub. Date: Jan. 22, 2004

(54) Method, device and program of providing education services for free talk services

(76) Inventors: Nozomu Saruhashi, Osaka (JP); Masahide Uemura, Osaka (JP); Katsunori Shimamoto, Osaka (JP); Yuu Yasumi, Osaka (JP)

Correspondence Address: FROMMER LAWRENCE & HAUG LLP, 745 Fifth Avenue, New York, NY, 10151, US

(21) Appl. No.: 10/338,582

(22) Filed: Jan. 8, 2003

(30) Foreign Application Priority Data
Jan. 10, 2002 (JP) 2002-003931

(51) Int. Cl. G06F 15/16

(52) U.S. Cl. 709/204

(57) ABSTRACT

To supplement the conversation amount which may become deficient in a conventional regular conversation and improve a practical applicability, a free talking service is provided which comprises: a step of generating a free talk classroom-table in the user connection table (20) provided in the multimedia communication server (10), a step of registering instructor terminal who can make a response in the above generated table, a step of receiving an entrance request from student terminals, a step of registering a student terminal for the table in case that there is a vacancy in the free talk classroom, a step of receiving an end request from student terminals, a step of deleting the student terminal submitting an ending request from the table, and to which a free entrance can be made. In addition, it further comprises a step of notifying the vacancy of the table, a step of establishing a waiting room in which a person waits for a free talk classroom, and a step of delivering a board in which established free talk classrooms are displayed.

### BACKGROUND OF THE INVENTION

1. Field of the Invention

The present invention relates to a method of providing an education service, a device of providing an education service and a program of providing an education service, which offer an education service via a communication line, especially to a method of providing an education service, a device of providing an education service and a program of providing an education service, which can remotely offer a language education service such as English conversation via a communication line such as Internet, etc.

2. Description of the Prior Art

Conventionally, as a method of providing an education service using a communication line, a method using a TV conference system as shown in FIG. 19 has been known. In the FIGS. 1a, 1b, . . . , 1n represent terminal units for TV conference, 2a, 2b, . . . , 2n and 5a, 5b, . . . , 5n represent communication lines, 3 represents a multi-point communication control unit which is connected with plurality of TV conference terminal units, and 4 represents a receipt terminal which receives the request for the conference. Each TV conference terminal unit has a TV displaying images, a TV camera for input of images, a head set including a microphone for input of sound and a earphone for hearing, and a personal computer including a TA (terminal adapter) and is connected to the communication control unit (3) and the receipt terminal (4) through a communication line. As to the communication line, a telephone line by ISDN used since it should be considered to get the service at home and to execute a image communication.

As to the estimation of “sports ability” as described above, “ranking” and “record” produced in an elimination match held by a sports organization or a large scale game are estimated, but the results produced in small-scale games such as local sports games are usually excluded and are not estimated. In actuality, therefore, even a good athlete of real ability cannot be appeared in “a stage for selection”, and then may terminate his athletic life without coming to a stage for selection.

On the other hand, a selector cannot select a good athlete because such good athlete cannot come to “a stage for selection”.

Under such circumstances, conventionally, investigators or scouts are sent to the whole country to perform an information collection or the like, which causes another problems that much more cost and much more time are needed.

Meanwhile, as to “foreign language conversation communication ability”, such ability can generate some advantages that it is possible to composedly cope with life abroad and to prevent athlete from bad mental effects owing to the difficulty of communication. Specifically, if an athlete has acquired “conversation power”, he can perform a dispute with a judge or a communication with other athletes in a harmonious manner, and as result, he can play with confidence in a game and can show his “sports ability” at a maximum.

In this way, since “foreign language conversation communication ability” exerts influence on “sports ability” of an athlete, it can be thought that it is an important consideration in selecting and appointing an excellent athlete.

In case where one notices a relation between said “foreign language conversation communication ability” and “sports ability” and aims for an improvement of communication ability in a foreign language, it is desired to develop an effective acquisition means because words used in each kind of sports, that is, technical terms are different.

If there is a good acquisition means, athletes and people who like sports will endeavor after learning a language, the desire to go “training abroad” or to assume a communication with people of other country will be increased, and it is possible to plan an internationalization of sports and further a progress of internationalization consciousness of a people.

In order to receive an education service by using the above-described TV conference system, a student should firstly telephone to a center having a receipt terminal and then select and register for a lesson of his own level among various lessons prepared in advance. When the estimated time for the lesson arrives, the student should again telephone to the center having a receipt terminal. After confirming that the person who has telephoned is a student who has registered for the lesson, the receipt terminal will connect a TV terminal of the corresponding student to the communication control unit. In addition, the receipt terminal will also connect a TV conference terminal of an instructor to the communication control unit. Thereby, each student can do a two-way communication with an instructor by TV image and sound to receive a lesson such as an English conversation. The communication control unit possesses an image-combining function and a screen-split function in order to cope with the case where more than 3 students participate in a lesson. Thereby, one instructor can do a lesson with plurality of students.

In a method of providing education services using such TV conference system, students have no need to go to the school and can receive a lesson at home in case that there is no school near the house, there is no time to go to school, or it is not easy to leave a house owing to children or weak person who need to be took care of at home. Further, since the lesson time can be flexibly adjusted, it is possible to easily realize a language education for a small number of students by native speakers, which has been proven as giving a high education effects.

However, in a method of providing an education service using such conventional TV conference system, since only a few lesson selected from a regular lesson menu previously prepared may be available, and one instructor is generally assigned for plurality of students and should proceed a lesson of a predetermined theme within a limited time, there have been problems such that it is difficult to ensure a sufficient amount of conversation necessary to improve the student's ability and to improve a practical applicability.

Therefore, the main object of the present invention is to provide an education service which makes it possible to supplement the conversation amount which may become deficient in a conventional regular conversation and improve a practical applicability.

### SUMMARY OF THE INVENTION

Claim 1 describes a method of providing education services which offers a conversational mode education service by possessing a user connection table which appoints the connected user of a terminal connected to a communication line, establishing a virtual classroom at student terminals used by students and instructor terminals used by instructors, and executing a two-way communication by multimedia information including TV image and sound, characterized in that it comprises:

a step of generating a free talk classroom table in which students can freely converse with instructors in said user connection table,

a step of receiving an entrance request into said free talk classroom from student terminals,

a step of registering the student terminal who has submitted the entrance request for the free talk classroom table when there is a vacancy in the free talk classroom,

a step of receiving an exit request from the above registered student terminals, and

a step of deleting the student terminal who has made the exit request out of from the free talk classroom table.

Claim 2 describes the method of providing education services according to claim 1, wherein said step of generating a free talk classroom table includes a step of registering, for said table, an instructor terminal used by an instructor who can respond to said free talk classroom.

Thereby, the instructor can respond to the free talk classroom via a terminal connected with a communication line. In addition, since an instructor terminal that is now responding to a free talk classroom can be relaid by another instructor terminal, it is possible to enlarge the flexibility of the instructor's service to provide an effective education service.

Claim 3 describes the method of providing education services according to claim 1 or 2, wherein said step of generating a free talk classroom table comprises a step of generating tables by objects of said free talk classroom, and

said step of receiving an entrance request comprises a step of receiving the entrance requests by objects of the free talk classroom.

Thereby, it is possible to offer an education service which can effectively improve the student's ability since the free talk classrooms can be established by its objects such as language, theme, level, etc. and a student can choose a free talk classroom which he wants.

Claim 4 describes the method of providing education services according to any one of claims 1 to 3, wherein said step of receiving an entrance request comprises a step of grouping students based on personal information of the students.

Thereby, it is possible to offer an education service which can effectively improve the student's ability since students can be grouped based on the student's personal information such as age, sex, hometown, hobby, special skill, etc. to promote an active conversation in each group.

Claim 5 describes the method of providing education services according to any one of claims 1 to 4, wherein it further comprises:

a step of registering the student terminal who has submitted an entrance request for a vacancy notice entry in case that there is no vacancy in the free talk classroom, and

a step of notifying any one student terminal registered for the vacancy notice entry in case that a vacancy happens in the free talk classroom.

Thereby, it is possible for a student to save a communication cost since there is no necessity to wait with holding the line in case that a free talk classroom he wants is full.

Claim 6 describes the method of providing education services according to any one of claims 1 to 5, wherein it further comprises:

a step of generating, in said user connection table, a waiting-room table to wait the entrance into said free talk classroom,

a step of registering the student terminal who has made the entrance request for said waiting-room table, in case that there is no vacancy in the free talk classroom,

a step of deleting any one of the student terminals registered for the waiting-room table in case that a vacancy happens in the free talk classroom, and

a step of registering said deleted student terminal for said free talk classroom table.

Thereby, it is possible to offer a education service having a high added value in case of a free talk classroom he wants is full, since a student connected to a waiting room can freely converse with other students connected to the same waiting room, and further, they can exchange their information or have a seminar.

Claim 7 describes a method of providing education services according to claim 6, wherein it further comprise:

a step of delivering contents into student terminals registered for said waiting-room table.

Thereby, it is possible to offer an education service having a high added value since video concerning a free classroom, advertising video, or advertisement of the service provider can be delivered to the students who are waiting in the waiting room in order to prevent a tediousness of waiting or in order to test or warm up a free talking service.

Claim 8 describes a method of providing education services according to any one of claims 1 to 7, wherein it further comprises a step of delivering a bulletin board which lists the free talk classrooms in a free talk classroom table.

Thereby, it is possible to confirm via on-line the presence or absence of vacancy in free talk classrooms which are now opened.

Claim 9 describes a method of providing education services according to claim 8, wherein entrance buttons are prepared in said bulletin board, and it comprises a step of registering said student terminal for said free talk classroom table when said button is selected by a student terminal.

Thereby, it is possible to offer an education service having a excellent handling since a student can enter a free talk classroom he wants to enter by clicking an entrance button displayed in the board.

Claim 10 describes a method of providing education services according to any one of claims 1 to 9, wherein it further comprises a step of collecting the time that a student terminal has been registered for the user connection table for the free talk classroom to bill the service fees to a person who utilized said free talking service.

Thereby, it is possible to bill a reasonable fee for various utilizing types of students since students are charged only for the time period during which they substantially remained in the free talk classroom.

Claim 11 describes a device of providing education services that can run the method of providing education services according to any one of claims 1 to 10 in a computer.

It is possible to realize an education service providing a free talking service by using a device of providing education services which can run each step of the method of providing education services according to any one of claims 1 to 10 in a computer.

Claim 12 describes a program for running the method of providing education services according to any one of claims 1 to 10 in a computer.

It is possible to realize an education service offering a free talking service by providing computer system with a program which can run each step of the method of providing education services described in any one of claims 1 to 10 in a computer.

The above described objects, other objects, characteristics and advantages of the present invention will be apparent from the below description of the embodiments of the invention by referencing drawings.

The present invention is more specifically described in the following paragraphs by reference to the drawings attached only by way of example.

### BRIEF DESCRIPTION OF THE DRAWINGS

The invention can better be understood by reference to the attached drawings, in which:

FIG. 1 is a schematic diagram of the system showing an embodiment of a device of providing education services in which the method of providing education services of the present invention is run.

FIG. 2 illustrates an example of personal information database (26).

FIG. 3 illustrates a drawing showing an example of subscription table.

FIG. 4 is a concept map showing the conversation function by means of a bi-directional communication server (12).

FIG. 5 is a flow chart showing the treatment order of a free talking service.

FIG. 6 illustrates an example of a user connection table.

FIG. 7 is a drawing showing a screen configuration of a free talk classroom.

FIG. 8 is a flow chart showing the treatment order of a registration of a person in a vacancy notification entry.

FIG. 9 is a flow chart showing the treatment order of a vacancy notification to a person who has registered in a vacancy notification entry.

FIG. 10 is a flow chart showing the treatment order of a receipt of an entrance request into a classroom.

FIG. 11 is a flow chart showing the treatment order of a response of a person who has been notified by e-mail.

FIG. 12 is a flow chart showing the treatment order of an entrance into a waiting room.

FIG. 13 is a flow chart showing the treatment order of an entrance into a free talk classroom from a waiting room.

FIG. 14 is a flow chart showing the treatment order of an exit from a waiting room.

FIG. 15 is a drawing showing a screen configuration of a waiting room.

FIG. 16 is a drawing showing a screen configuration of a board listing free talk classrooms which are now open.

FIG. 17 is a flow chart showing the treatment order of the start of counting in a billing procedure.

FIG. 18 is a flow chart showing the treatment order of the end of counting in a billing procedure.

FIG. 19 is a schematic diagram showing a TV conference system used in a conventional method of providing education services.

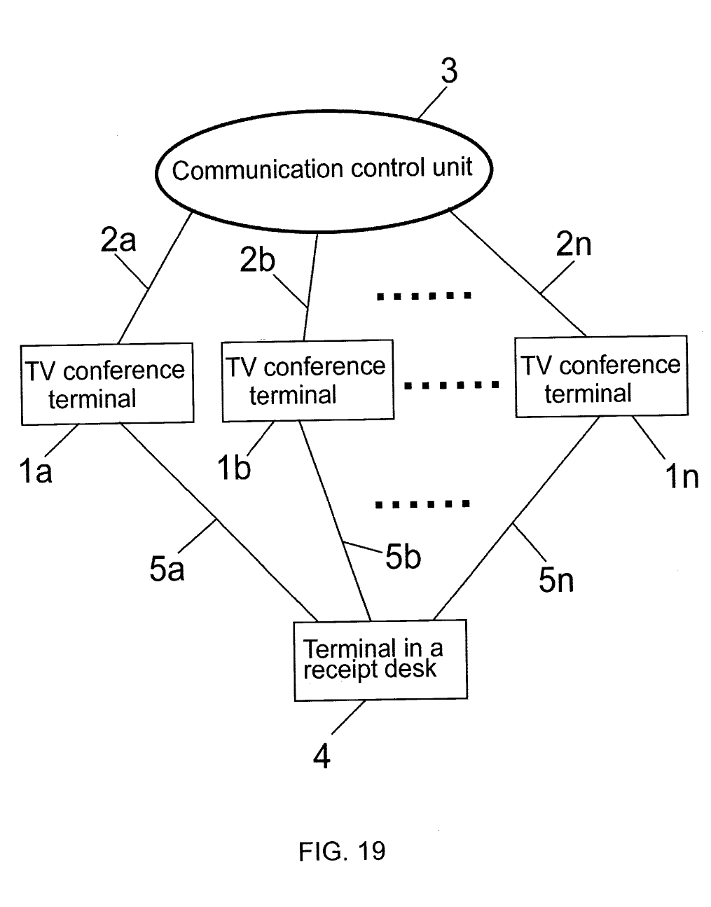

In drawings, symbols represent as follows:

10: device of providing education services

12: bi-directional communication server

14: contents delivery server

16: web server

18: communication line connection device

20: communication line

22: user connection table

24: contents database

26: personal information database

30: exit button from a free talk classroom

40: exit button from a waiting room

42: entrance button into a free talk classroom from a waiting room

### DETAILED DESCRIPTION OF THE PREFERRED EMBODIMENTS

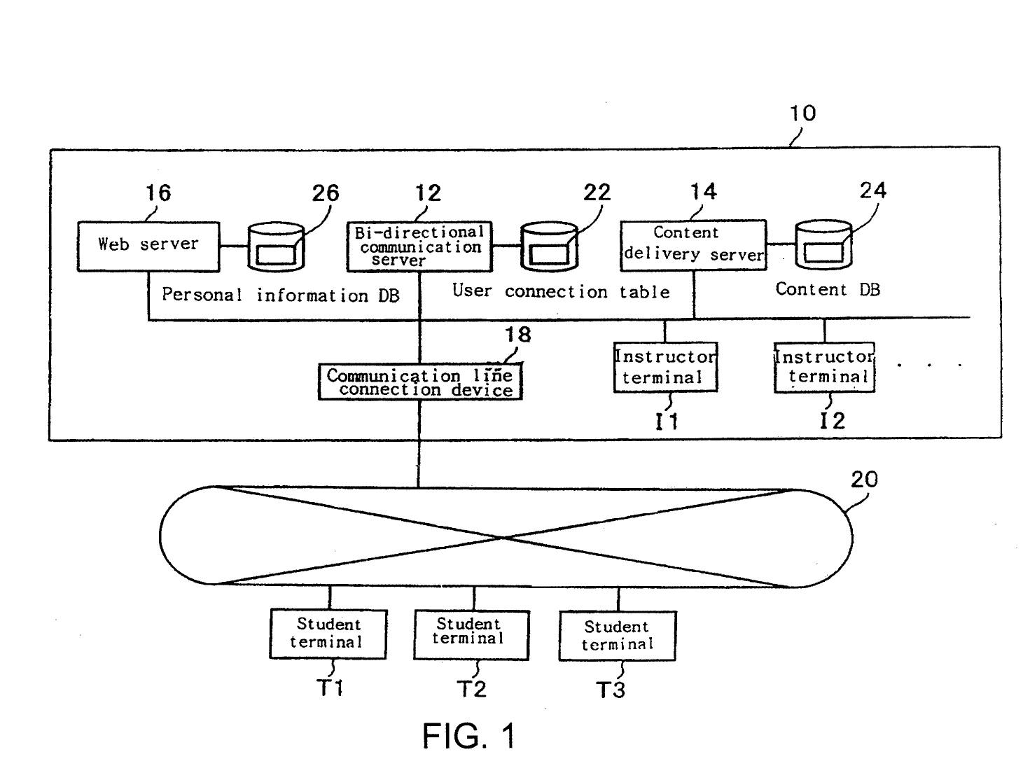

FIG. 1 is a schematic diagram of the system showing an embodiment of a device of providing education services which realizes the method of providing education services of the present invention.

In Figures, 10 represents a device of providing education services, to which a bi-directional communication server (12), a contents delivery server (14), a web server(16), an instructor terminal(I1, I2, . . . ) used by an instructor and a communication line connection device (18) are connected through a network and to which student terminals (T1, T2, T3, . . . ) are connected through a communication line (20) upon offering a service.

A bidirectional communication server (12) is provided with a user connection table (22) in which the connected terminals are registered, and connects between the terminals registered in said user connection table (22) to provide a two-way communication function by means of multimedia information including TV image and sound. That is, it receives image and sound transmitted from each terminal registered in the user connection table (22), combines the received image and sound, and transmits the combined image and sound to each terminal registered in the user connection table (22).

A content delivery server (14) is provide with a contents database (24) which memorizes multimedia contents such as dynamic image, static image, sound, text, sound effect, etc., and delivers assigned contents to terminals registered in the user connection table (22).

A web server (16) is provided with a personal information database (26) which memorizes personal information of students, confirms the access authority of the connected terminals, and delivers the web page for offering an education service into terminals having the access authority.

Communication lines (20) can adapt to any type of communication lines including wireline and wireless computer network, telephone line, satellite line, Internet, etc. The present invention is explained with the assumption that the communication line is Internet.

Therefore, the communication line connection device (18) uses an Internet router in order to connect to Internet.

An instructor terminal (I1, I2, . . . ) comprises a computer composed of a TV camera obtaining instructor's image, a microphone obtaining instructor's sound, a monitor screen displaying images, a speaker generating sound, input devices such as keyboard, mouse, etc., interface devices for the TV camera and microphone and a network connection device, and has a function of obtaining instructor's image and sound and transmitting them to a bi-directional communication server (12), a function of outputting image and sound transmitted from a bi-directional communication server (12) on a monitor screen and a speaker, a function of outputting image and sound delivered from a contents delivery server (14) on a monitor screen and a speaker, and a function of displaying image delivered from the web server (16) on a monitor screen and transmitting to the web server (16) the input device information operated on the monitor screen.

Meanwhile, a student terminal (T1, T2, T3, . . . ), as the same with an instructor terminal, comprises a computer composed of a TV camera obtaining student's image, a microphone obtaining student's sound, a monitor screen displaying images, a speaker generating sound, input devices such as keyboard, mouse, etc., interface devices for the TV camera and microphone and a network connection device (for example, TA, etc.), and has a function of obtaining student's image and sound and transmitting them to the bi-directional communication server (12), a function of outputting image and sound transmitted from the bi-directional communication server (12) on a monitor screen and a speaker, a function of outputting image and sound delivered from the content delivery server (14) on a monitor screen and a speaker, and a function of displaying image delivered from a web server (16) on a monitor screen and transmitting to the web server (16) the input device information operated on the monitor screen.

Next, services offered by a device of providing education services (10) according to the present invention are explained. A person who will get a service is registered as a member and is requested to input his personal information into a personal information database (26).

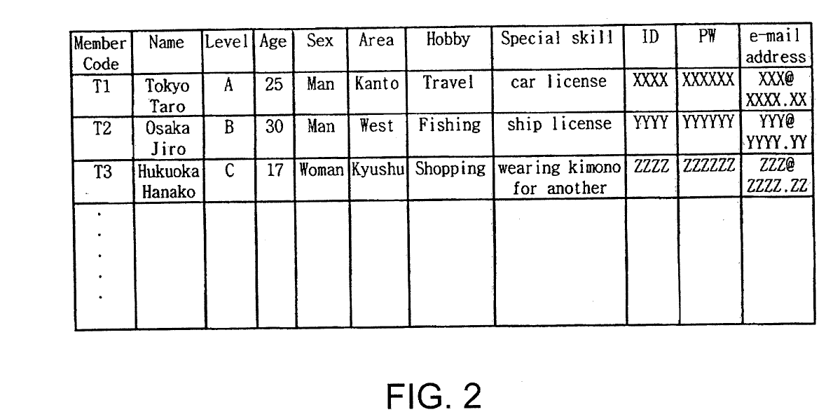

FIG. 2 illustrates an example of personal information database (26). As shown in the Figure, personal information including member code, name, level, age, sex, area, hobby, special skill, etc. as well as ID, password, mail address, etc. used in access to the device of providing education services (10) are registered. Such registration can be made by an operator of an education service center, as well as an applicant accesses a joining page (not shown) provided in the web server (16) via a student terminal and inputs his/her personal information according to the instruction of the screen to automatically receive ID and password and register his personal information into a personal information database (26).

A member who has joined as described above can get an education service by accessing member's page (hot shown) provided in a web server (16) via a student terminal and logining with ID and password.

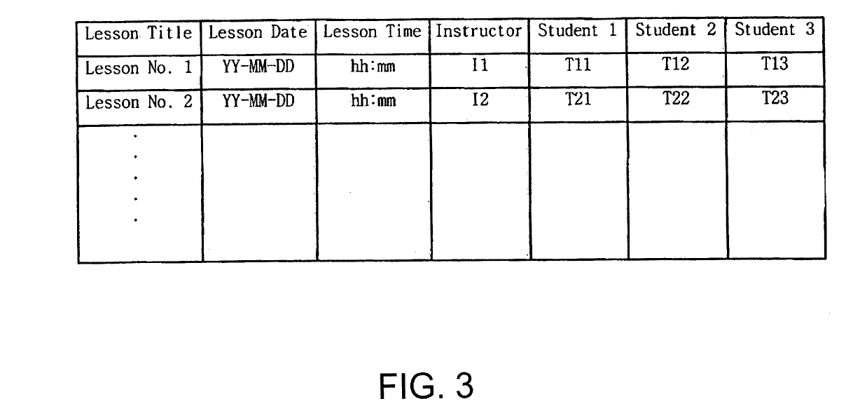

Firstly, the procedure that a member gets a general lesson is explained. As to a general lesson, a member should telephone to an education service center or login the member's service page of the web server (16) to register for a desired lesson. Thereby, in a subscription table as shown in FIG. 3, there are registered the lesson title, date and time of the lesson, responding instructor's code, student's member code, etc.

The subscribed member should login into the member's service page at the lesson time of the lesson date to notify his/her attendance at the lesson. The web server (16) confirms that the logined member is a subscriber registered in the subscription table, and notifies the terminal address (for example, IP address, etc.) of the corresponding student terminal to the bi-directional communication server (12), and the bi-directional communication server (12) records said terminal address of the student terminal in a user connection table (22). In addition, the web server(16) notifies terminal address of the corresponding instructor terminal responding an lesson to the bi-directional communication server (12), and the bi-directional communication server (12) records said terminal address of the instructor terminal in the user connection table (22).

Thereby, a connection between each terminal and the bi-directional communication server is established, each terminal inputs image of a TV camera and sound of a microphone, and said image and sound inputted are transmitted in real time to the bi-directional communication server (12). The bi-directional communication server (12) receives the images and sounds transmitted from each terminal, combines the images and sounds into the composite image and sound to be delivered into each terminal, and then delivers the composite image and sound to each terminal. Each terminal receives image and sound delivered from the bi-directional communication server (12), displays said image on a monitor screen with a generation of a window, and outputs said received sound through a speaker. Thereby, a virtual classroom for lesson is established on the bi-directional communication server (12) and terminals registered in the user connection table (22) are provided with a conversation function between them by means of image and sound.

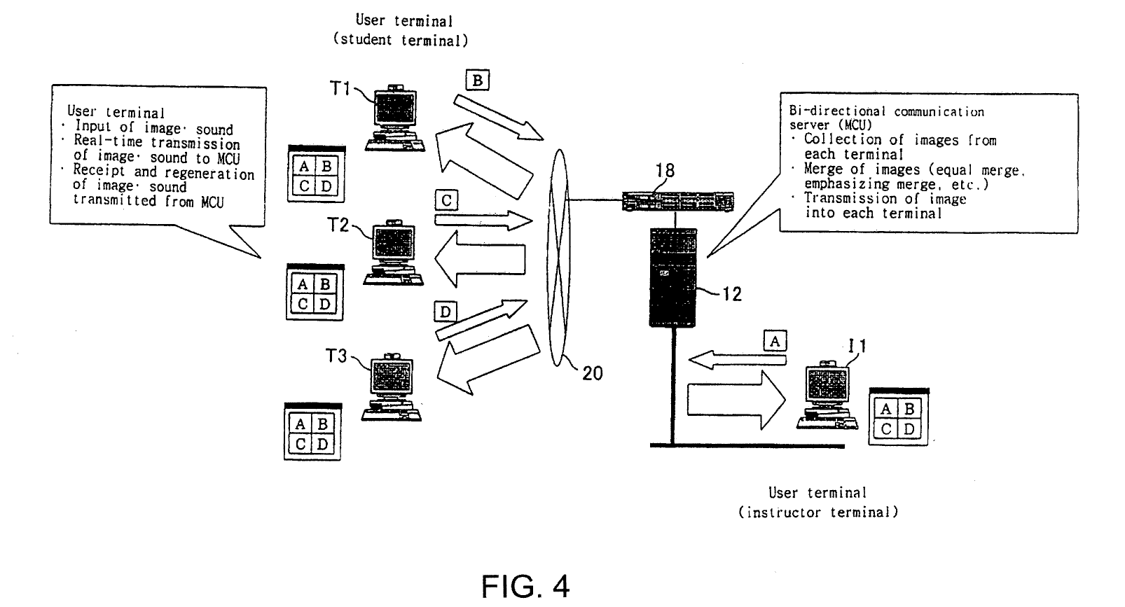

FIG. 4 illustrates a concept map showing the conversation function by means of a bi-directional communication server (12). The figure illustrates a case that one instructor and three students are in a classroom. The images and sounds of said instructor and students are equally combined and then four images are displayed on the screen of each terminal in a quad-screen. Said composite image and sound can be made in an equal manner as well as in a weighted manner in which image and sound of any one terminal among four terminals are emphasized and said weighted composite can be chosen by an operation in the instructor terminal. Said choosing operation by an instructor terminal can be realized by the procedures that the web server (16) delivers a page (not shown) having a choosing button of the combining function into an instructor terminal and sends the instructor's operating information on the delivered page to the bi-directional communication server (12).

Maximum number students who can entering one virtual classroom is restricted by the resolution of the combined screen displayed in each terminal, the treatment ability of the bi-directional communication server (12) or the like. And the number of virtual classrooms which can be simultaneously established is restricted by the treatment ability of the bi-directional communication server (12), the available band of the communication lines, or the like. It is possible to prescribe the number in advance or to allow the number to be dynamically chosen according to the current status or the band of the communication lines.

In addition, a content delivery server (14) cumulates multimedia data used in the lessons in a content database (24) and delivers the contents appointed by the instructor terminal to each terminal. Each terminal displays images delivered from the content delivery server (14) on a monitor screen and makes a sound with a speaker. The appointment of the delivered contents by the instructor terminal is realized by delivering a selection page (not shown) to the instructor terminal by the web server (16), and by transmitting the operation information against the delivered screen to the content delivery server (14).

As described above, according to the device of providing education services (10) of the present invention, since the instructor and each student can receive the delivered multimedia teaching materials from the contents delivery server (14) as well as can converse with each other by the bi-directional communication server (12), it is possible to obtain even in a remote place the same effects that they get a lesson in the same room and with the common teaching materials.

In order to offer other advanced education services, the bi-directional communication server (12) can be provided with the following application-data sharing function.

If a share application is executed in an specific terminal registered in a user connection table (22), the corresponding terminal transmits the screen of share application under execution to the bi-directional communication server (12) iteratively. The bi-directional communication server (12) delivers the received screen of the share application into other terminals registered in a user connection table (22). The terminal with delivery displays the share application screen delivered from the bi-directional communication server (12). Thereby, the terminal to which a delivery has been made can operate the share application, and the operated data or information is returned by feedback to the terminal in which the shared application is running. Thereby, it is possible to offer an advanced service since a cooperative work by all users can be made by using application programs such as word processor, spread sheet, clip art, etc. For example, it is possible to do a text-base chatting by sharing a text-input screen or to do a discussion by using a white board on which text and figure can be drawn.

Next, the procedure to offer a free talking service which is a peculiar function of the present invention by using a device of providing education services (10) according to the present invention is explained. The free talking service is to offer a space in which a free talk classroom in which an instructor habitually reside is established in a bi-directional communication server (12) and members can freely enter to converse with the instructor(s).

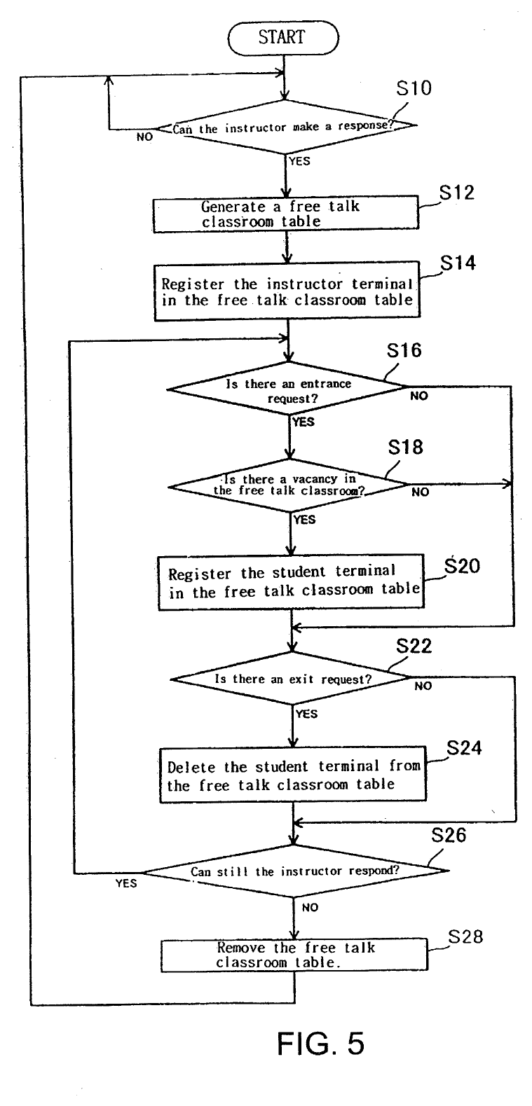

FIG. 5 illustrates the treatment of a free talking service. At first, the procedure is to decide whether the instructor can make a response at S10, to generate at S12 a free talk classroom table in the user connection table (22) in case that the instructor can respond, and to register at S14 a terminal address of the instructor terminal corresponding to the generated free talk classroom table. Thereby, a free talk classroom in which the corresponding instructor habitually resides is established to start a free talking service.

Next, the procedure is to decide at S16 whether there is any entrance request into the corresponding free talk classroom, and to decide at S 18 whether there is a vacancy in the corresponding free talk classroom in case that there is any entrance request. In case that there is a vacancy, the terminal address of the corresponding student terminal is registered at S20 in the corresponding free talk classroom table. Thereby, a member can enter a free talk classroom at any time and can have a free conversation with an instructor who habitually reside in the free talk classroom by the bi-directional communication server (12). In case that there is no entrance request at S16 or no vacancy at S18, S20 is skipped and the procedure goes to S22. As to the receipt of entrance request, it is possible to cope with the entrance request of many members by generating an entrance-request-receipt table (not shown), registering terminal addresses of student terminals in the entrance-request-receipt table on a first-come-first-served basis when there is an entrance request of a member via the web server (16) as described in below, and taking out at S20 terminal addresses of student terminals one by one from the first in the entrance-request-receipt table. Further, it is possible to decide whether there is a vacancy in a free talk classroom by deciding whether all the columns of student terminals established in the table are recorded or not. And this can be decided by firstly determining the maximum number of students in one virtual classroom of the bi-directional communication server (12) and then deciding whether the number of students already registered is the same with the above-determined maximum number of students in one virtual classroom.

Next, the procedure is to decide whether there is any exit request out of the corresponding free talk classroom at S22, and to delete at S24 the terminal address of the corresponding student terminal from the corresponding free talk classroom table. Thereby, the corresponding student can exit out of the free talk classroom at any time. In case that there is no exit request, S24 is skipped.

Lastly, the procedure is to decide whether the corresponding instructor can still make a response, and to return to S16 to receive an entrance request in case that the instructor can make a response. In case that the instructor cannot make a response, the procedure is to remove the corresponding free talk classroom table from the user connection table (22) and to return to S10. Thereby, the corresponding free talking service is ended.

In the above embodiment, it is explained that a free talk classroom is established at S12 when an instruction can make a response and closed at S28 when the instructor cannot make the response any more, but the present invention is not limited to this embodiment and it is possible to open a free talk classroom at all times and to restrict the entrance of members when an instructor cannot make the response.

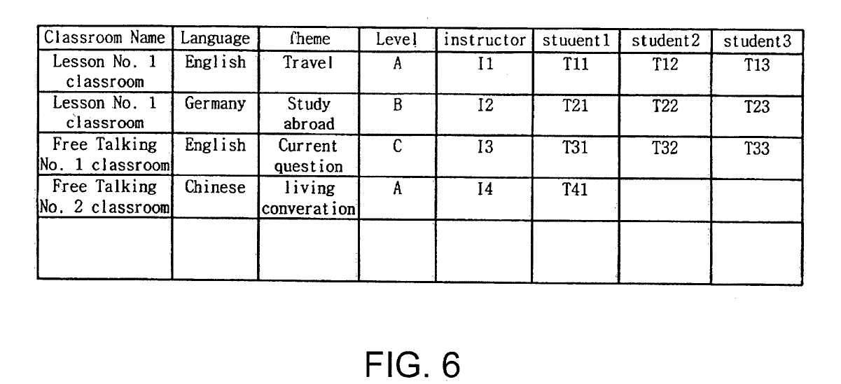

FIG. 6 illustrates an example of a user connection table when a free talk classroom is established according to the above procedure. As shown in the Figure, in the user connection table (22) are registered classroom title, language, theme, level, instructor and the maximum number of students in one classroom. Here, it represents a state that two general lessons and other two free talk classroom with different theme and level are established. It is explained that the instructor and students to be registered in user connection table (22) are directly registered as to their terminal address, but it is possible to register the instructor code or member code and then determine a terminal address of the connected terminal by referencing a terminal address table (not shown) separately prepared. In case that terminal address is determined when connected with Internet, it is possible to register the terminal address in the terminal address table when the terminal logins.

In the above embodiment, since terminal address of an instructor terminal is registered when establishing a free talk classroom, the corresponding instructor can respond to the free talk classroom through a terminal connected to a communication line. In addition, since an instructor terminal which is now responding to a free talk classroom can be relaid by another instructor terminal, it is possible to enlarge the instructor's flexibility to respond to the service, by which an effective education service can be provided. In such case, the present invention is not limited to the above, and it is also possible to generate a free talk classroom table for each instructor terminal.

In the above embodiment, it is explained that one instructor is assigned to one free talk classroom, but the present invention is not limited to the above and it is possible to assign more than two instructors to one free talk classroom. In such case, a user connection table is provided with plurality of registration column for instructor terminals and the terminal addresses of suitable plurality of instructor terminals are registered at S14 of the above treatment procedure.

In the above user connection table, an establishment of free talk classrooms by objects including language, theme, student's level, etc. is shown. This can be realized by a simultaneously treating the procedure of the above free talking service by objects. In such case, the above-described entrance request receipt list is prepared by the free talk classrooms under the establishment and the entrance request into each free talk classroom is register for each corresponding entrance request receipt list in the order of the receipt, and the early request is treated first.

As such, by establishing free talk classrooms by objects of language, theme, student's level, etc., students can freely select a classroom which is suitable for his object, and therefore, it is possible to offer an education service which can effectively improve the student's ability.

In addition, it is possible to establish plurality of free talk classrooms having the same object and to assign students to each free talk classroom after grouping the students based on their personal information.

For example, it is possible to assign No. 1 free talk classroom for men and middle age and No. 2 free talk classroom for women and young age and to register the corresponding student terminal for the entrance request list of the corresponding free talk classroom, when receiving the above-described entrance request by referencing the personal information database (26). Further, it is possible to assign students to each free talk classroom by one student per one classroom at first, and then to assign each student who wants to enter a free talk classroom to a suitable free talk classroom in which there are the students with similar age, hobby, etc. by referencing the personal information database (26).

As such, by establishing a plural of free talk classrooms and grouping students based on personal information such as student's age, sex, hometown, hobby, special skill, etc., it is possible to offer an education service which can make the conversation at the free talk classroom active and can effectively improve the student's ability.

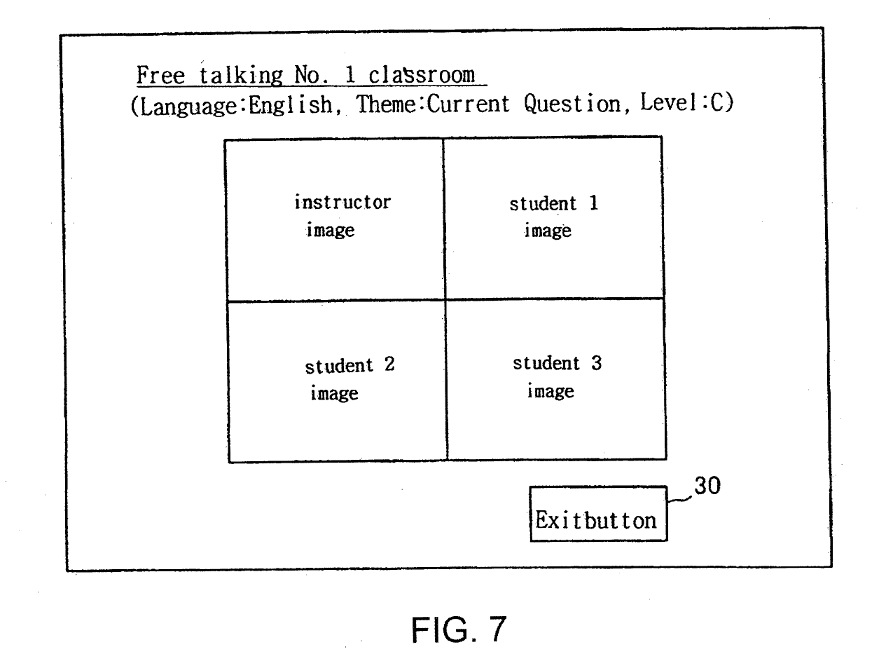

FIG. 7 illustrates a screen configuration of a free talk classroom established as such. As shown in the Figure, the classroom title and the object of language, theme, level, etc. are displayed at the top of the screen. At the middle of the screen, the images of instructors and students who enter the classroom are displayed and they can converse with watching the other party's face image. In addition, it is possible to deliver contents by an instruction of the instructor (not shown). At the bottom of the screen, there is an exit button with which a student can input his request to exit from the classroom. When a student at a classroom clicking said exit button, the corresponding information is transmitted to the web server (16), and a student terminal in which the corresponding student have clicked the exit button at S24 of the above procedure is removed the corresponding free talk classroom table.

In the above embodiment, a free talk classroom is illustrated as being previously established by its object, but it is possible to invite all members to submit a request of establishing a free talk classroom which is specified by its objects such as language, theme, level, etc. and then to assign the instructor terminal according to the above request by referencing a schedule management table (not shown) of the instructor. Thereby, it is possible to offer a free talking service which is more convenient to use.

Next, a procedure is explained in case that the free talk classroom is full.

In case that a free talk classroom is full, members can take two measures, one method is to register for a vacancy notification entry and login into the member service page in order to receive a vacancy notification when a vacancy happens in the free talk classroom, and another method is to enter a waiting room established in a bi-directional communication server (12) and then wait until a vacancy happens in the free talk classroom.

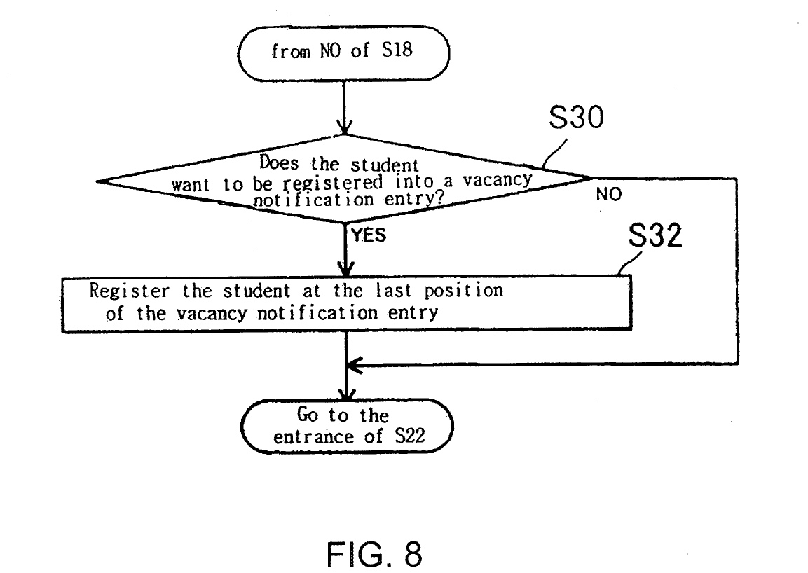

FIGS. 8 to 11 illustrate the treatment order when a person is registered in a vacancy notification entry.

FIG. 8 illustrates the treatment of a registration of a vacancy notification entry. This is inserted into the NO side of S18 in the above treatment order of the free talking service, and is to decide whether there is a registration request in the vacancy notification entry at S30, to register at S32 the corresponding student terminal at the last of the vacancy notification entry in case that there is a registration request, and to skip S32 in case that there is no registration request. The registration request in a vacancy notification entry can be received through the board delivered from the web server (16) as described below.

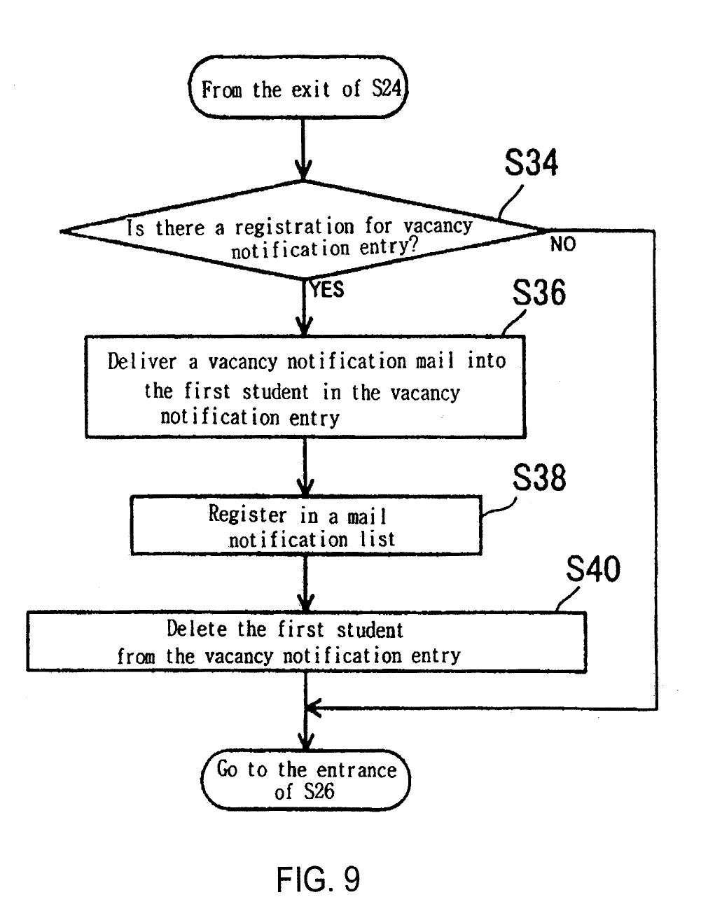

FIG. 9 illustrates the treatment of a vacancy notification to a person who has registered in a vacancy notification entry. This is inserted into the exit side of S24 in the above treatment order of the free talking service, and is to decide whether there is a registered person in the vacancy notification entry, to deliver a vacancy notification mail at S36 to the first student in the vacancy notification entry in case that there is a registered person, to register the corresponding student at S40 in a mail notification list, and to delete the student in question at S42 in the vacancy notification entry. If there is no registered person, S36 to S40 are skipped.

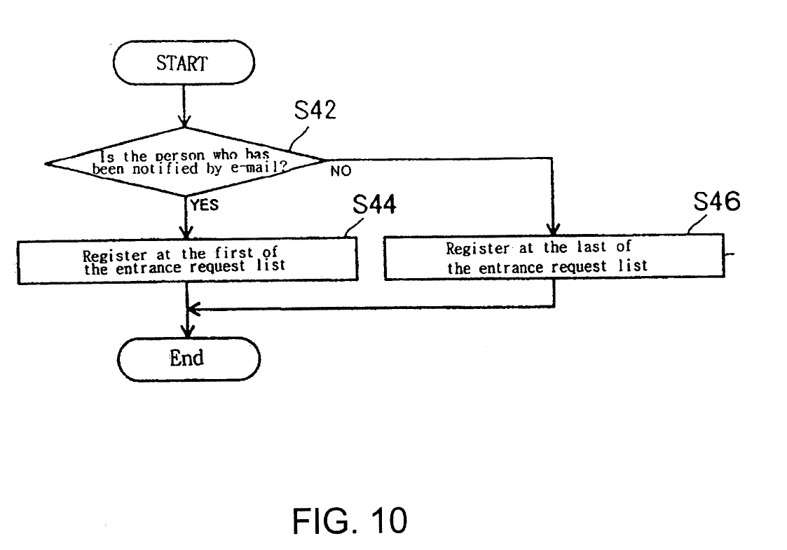

FIG. 10 illustrates the treatment of a receipt of an entrance request. This is the treatment when receiving an entrance request of a member and is to decide whether the corresponding student is a person who has been notified with mail by referencing the above mail notification list, to register the corresponding student terminal at S44 at the first position of the entrance request list when the corresponding student is the person who has been notified with mail, or to register the student terminal in question at S46 at the last position of the entrance request list when the student in question is not the person who has been notified with mail. Thereby, the person who has been notified with mail can preferentially enter a classroom when he wants to enter therein.

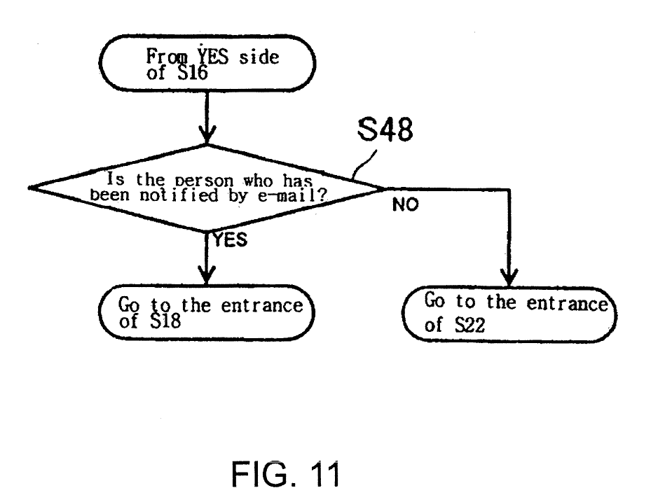

FIG. 11 illustrates the treatment of a response of a person who has been notified by e-mail. This is inserted into YES side of S16 in the above treatment order of the free talking service, and is to decide whether the student is the person who has been notified by an e-mail, to go to the entrance of S18 in case of the person who has been notified by an e-mail, and to go to the entrance of S22 in case that the student is not the person who has been notified by an e-mail. Thereby, it is possible to prevent other member from entering until the person notified by e-mail responds to the notification. However, there is a problem that nobody cannot enter if the person is notified by e-mail does not respond. The above problem can be solved by recording, in the mail notification list, the time that a notification mail is delivered to a student at S38 and by deleting the corresponding student from the list when a predetermined time has passed from the notified time.

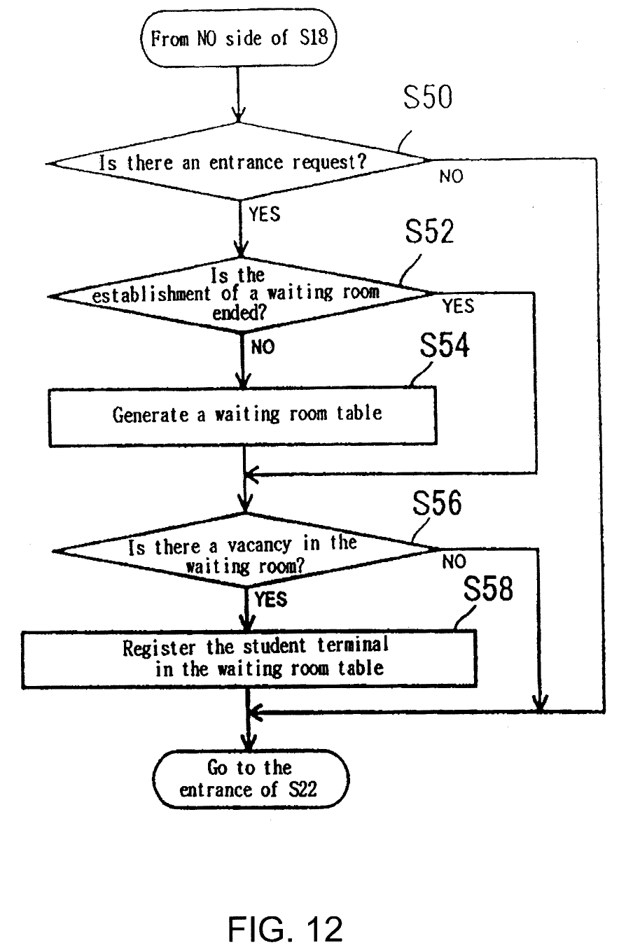

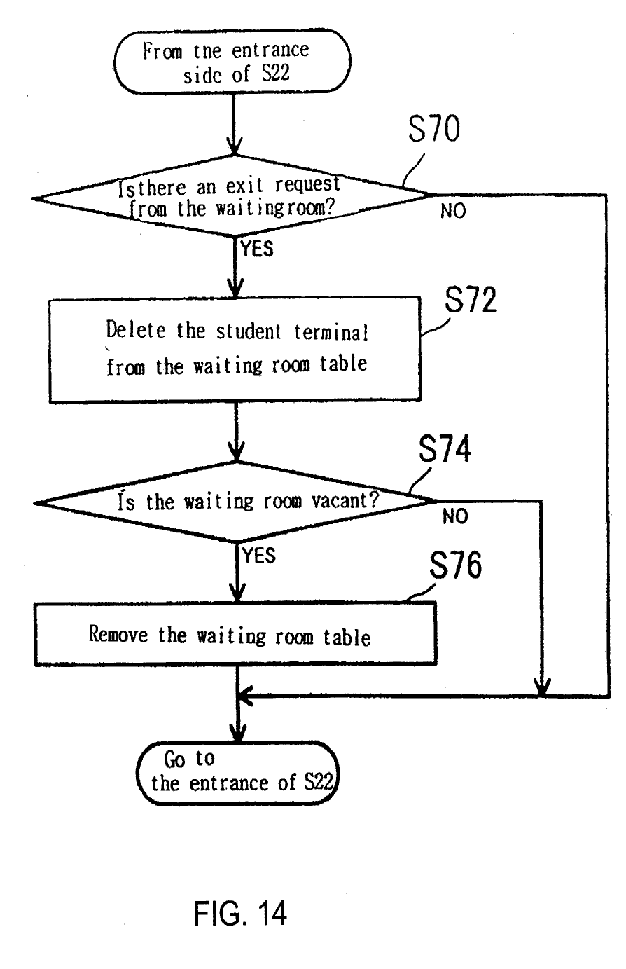

In FIGS. 12˜FIG. 14 illustrate the treatment order when there is a waiting room.

FIG. 12 illustrates the treatment of an entrance into a waiting room. This is inserted into the NO side of S18 in the above treatment order of the free talking service, and is to decide whether there is an entrance request at S50. When there is an entrance request, it is determined whether a waiting room has been already established at S52. If not, a waiting-room table is established in the user connection table (22) at S54. Thereby, a waiting room for waiting a free talk classroom is established in the bi-directional communication server (12). S54 is skipped when a waiting room has been already established. Next, it is determined whether there is a vacancy in the waiting room in question at S56, and if there is a vacancy, the student terminal in question is registered in the waiting-room table at S58. Thereby, the student in question can enter a waiting room for waiting a free talk classroom and make a free conversation with other students in the waiting room via the bidirectional communication server (12). If there is no vacancy, S58 is skipped. In addition, if there is no student wanting to enter therein, the treatments from S52 to S58 are skipped. After the above procedure is ended, the procedure is returned to S22 of the treatment order of the above free talking service.

Since the receipt of entrance request into a waiting room can be realized by the same treatment with the entrance request into a free talk classroom, the explanation thereof is omitted.

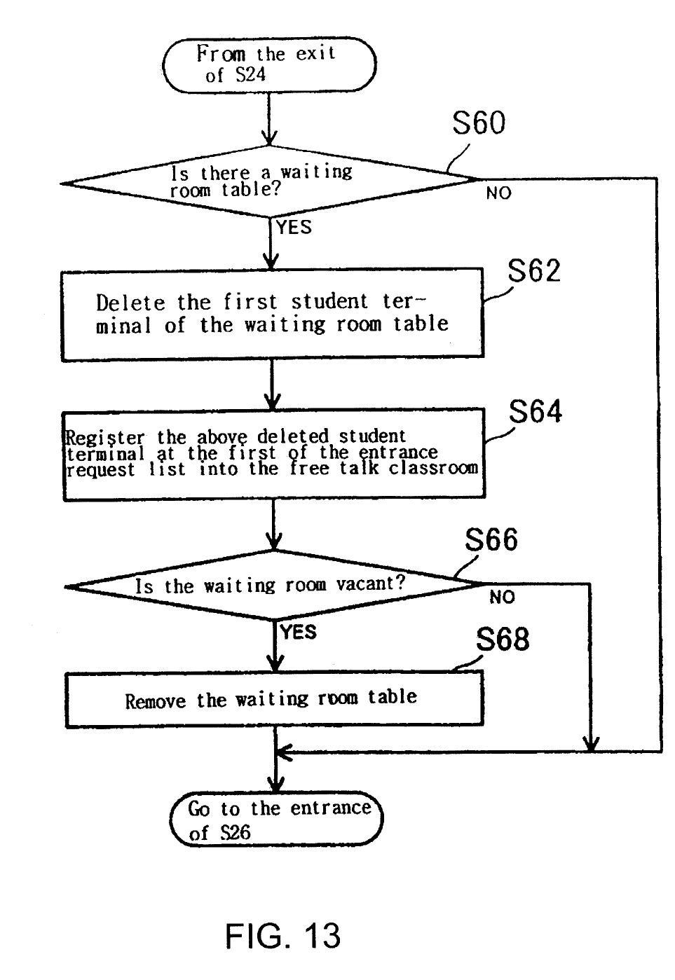

FIG. 13 illustrates the treatment of an entrance into a free talk classroom from a waiting room. This is inserted into the exit side of S24 in the above treatment order of the free talking service, and is to decide whether there is a waiting-room table at S60. If there is a waiting-room table, the first student terminal at the waiting-room table is deleted at S62 and then registered at S64 at the first of the request list for the entrance into the free talk classroom. Thereby, a student who has first entered the waiting room is considered as the most preferential student to enter the free talk classroom. Next, since a student exits from the waiting room, a determination is made at S66 whether the waiting room is vacant and, if it is vacant, the corresponding waiting-room table is removed at S68 in the user connection table. Thereby, the waiting room is closed. If the waiting room is not vacant, S68 is skipped. In addition, if there is a waiting-room table at S60, the procedure of S62 to S68 is skipped. After the above procedure is ended, the procedure is returned to S26 of the treatment order of the above free talking service.

FIG. 14 illustrates the treatment of an exit from a waiting room. This is inserted into the entrance side of S22, and is to decide whether there is a request to exit from the waiting room at S70. If there is a exit request, the corresponding student terminal is deleted at S72 from the waiting-room table. Thereby, a student who has entered the waiting room can abandon to enter the free talk classroom and exit from the waiting room at any time. Next, since a student exits from the waiting room, a determination is made at S74 whether the waiting room is vacant and, if it is vacant, the corresponding waiting-room table is removed at S76 in the user connection table. Thereby, the waiting room is closed. If the waiting room is not vacant, S76 is skipped. In addition, if there is no request to exit from the waiting room at S70, the procedure of S72 to S76 is skipped. After the above procedure is ended, the procedure is returned to the entrance side of S22 of the treatment order of the above free talking service.

In the above embodiment, a waiting room is illustrated as being established at S54 if necessary and closed at S68 or S76 when it becomes vacant, but it is possible to establish and open a waiting room at all times.

Since the device of providing education services (10) according to the present invention is provided with a content delivery server (14), it is possible to deliver contents to each student at a waiting room by using the content delivery server. This can be realized, for example, by instructing the content delivery server (14) to deliver predetermined contents to the student terminal registered in a waiting-room table when generating a waiting-room table of S54.

Thereby, it is possible to offer a education service having a high added value since students who are waiting can be provided with free or advertising video concerning a free classroom or an advertisement of the service provider in order to prevent a tediousness of waiting or in order to test or warm up a free talking service.

In addition, it is possible to provide students who are waiting in a waiting room with an on-line game function by utilizing the above described application-data sharing function of the bi-directional communication server (12) or with a seminar function by using various education tools.

Thereby, it is possible to provide the member who is in a remote place with the same effects that they are waiting an education service at a lobby in which there is a receipt desk of official or private education facilities.

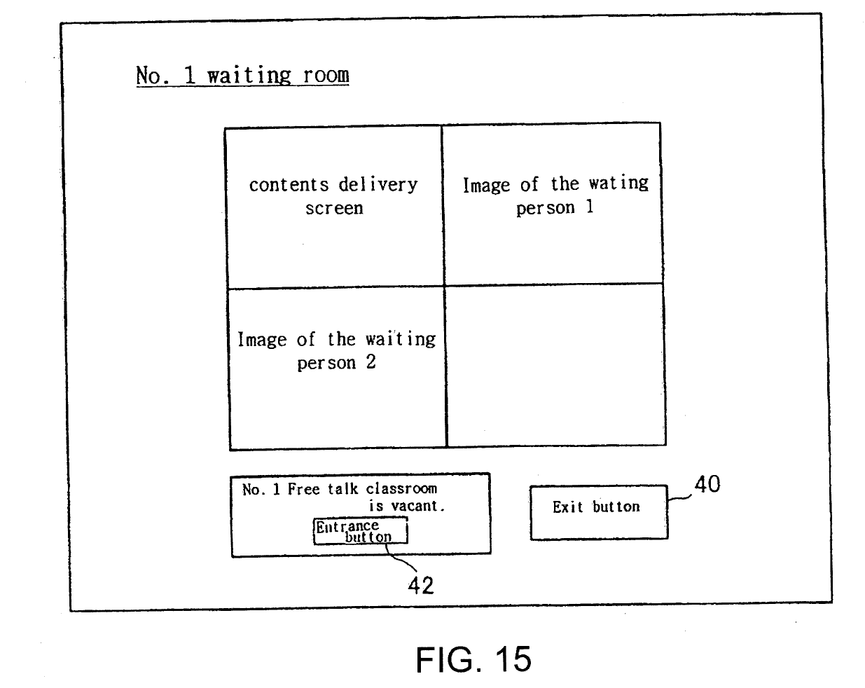

FIG. 15 illustrates a screen configuration of a waiting room. As shown in the Figure, three students who are waiting in the No. 1 Waiting Room can utilize the delivered contents or converse with each other with seeing their images. In addition, when a vacancy happens in the free talk classroom, a message notifying the vacancy is displayed in the bottom of each screen and a student can enter the free talk classroom by clicking an entrance button prepared in the message. In addition, an exit button is also prepared in the bottom of each screen and a member who abandons to enter the free talk classroom can exit from the waiting room at any time by clicking the exit button.

Next, the service to deliver a board which lists the free talk classrooms to a member. This is to deliver a list of the established free talk classrooms to student terminals by web server (16) and a member can receive it by login in the member service page.

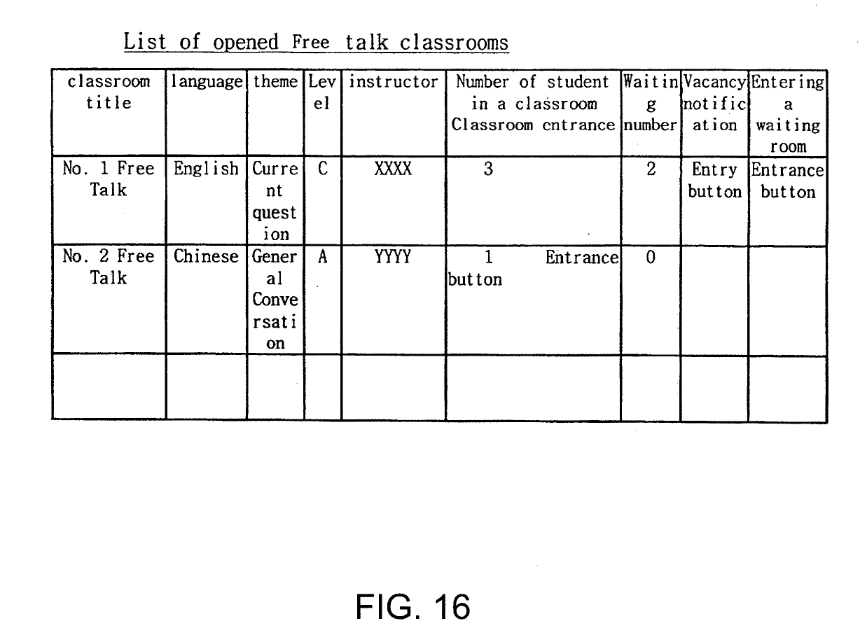

FIG. 16 illustrates an example of a board and displays the classroom title, language, theme, level, instructor name, the number of attendance, the number of waiting students. Thereby, it is possible for members to confirm the type of free talk classrooms and the status of vacancy via on-line.

As shown in the Figure, it is possible to display an entrance button in the entrance box in case that there is a vacancy in the classroom and to receive an entrance request of S16 in the treatment order of the free talk classroom when the entrance button is clicked by a member. In addition, it is possible to display an entry button in the vacancy notification box in case that there is a waiting to enter the free talk classroom and to consider the clicking of the entry button by a member as wanting to be registered at S30 of the treatment of vacancy notification entry registration. In addition, it is possible to display an entrance button in the entrance box into the waiting room in case that there is a waiting to enter the free talk classroom and to consider the clicking of the entry button by a member as wanting to enter the waiting room.

Thereby, it is possible to offer a education service having a excellent handling since a student logins into the member page, can enter a free talk classroom by a mouse operation in case that there is a vacancy, or can receive a vacancy notification service or enter a waiting room by a mouse operation even in case that there is no vacancy.

In the above embodiment, a waiting room is illustrated as being established for the waiting when a free talk classroom is full, but it is possible to establish a waiting room which a person can enter at any time and to display a board in it. Thereby, it is possible for a member to confirm at a waiting room the status of a free talk classroom, and to enter the desired free talk classroom or to move to a waiting room for the free talk classroom according to the status.

Lastly, a method of billing the fees for the free talking service is explained. Since a student enters the free talk classroom to have a free talking with an instructor or other students to supplement the conversation amount which is deficient and improve a practical applicability, it is preferable to make a billing on the basis of time that a member is practically remained in the classroom. In the device of providing education services (10) according to the present invention, since the time that a student is practically remained in the classroom is corresponding to the time registered in the free talk classroom table of the corresponding student terminal, the above billing method can be easily realized by collecting them.

Therefore, a service time-rate timer for the free talk classroom is established for each member.

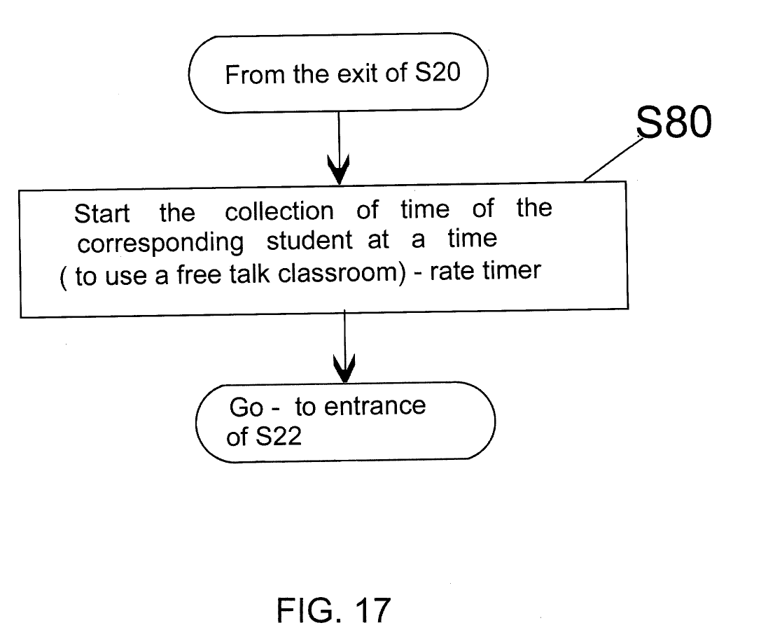

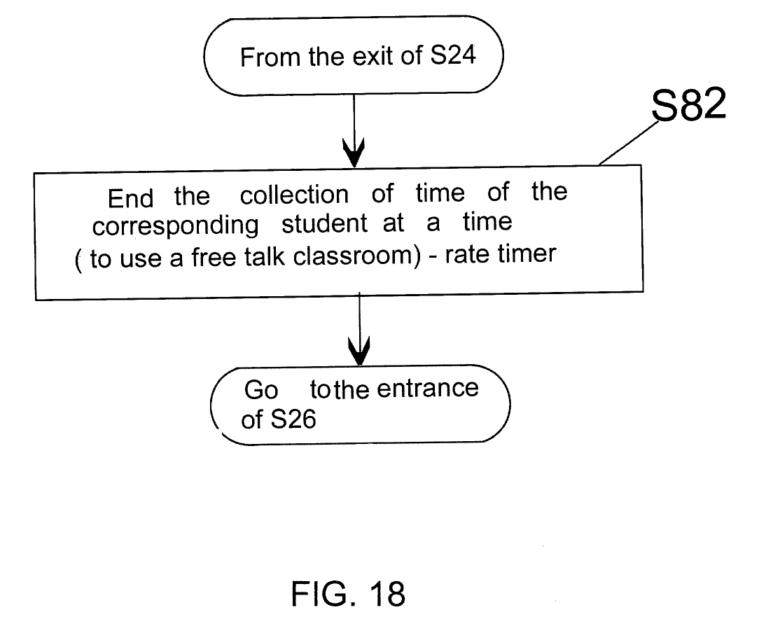

FIG. 17˜FIG. 18 illustrates examples of the treatment order in a billing procedure of the free talking service.

FIG. 17 illustrates the treatment of the start of counting. This is inserted into the exit side of S20 in the above treatment order of the free talking service, and starts at S80 the counting of service time of a student to use a free talk classroom and returns to S22.

FIG. 18 illustrates the treatment of the end of counting. This is inserted into the exit side of S24 in the above treatment order of the free talking service, and terminates at S82 the counting of service time for a student to use a free talk classroom and returns to S22.

Thereby, the service fee can be calculated by referencing a counting timer of the service time to use a free talk classroom, in which it is possible to obtain a cumulative service time of each member to use a free talk classroom.

In addition, it is possible to utilize a prepaid system wherein prepaid points are given to a member and points corresponding to the cumulative service time using a free talk classroom are removed.

Thereby, it is possible to bill a reasonable fee for various utilizing types of students since students are charged only for the service time during which they substantially remained in the free talk classroom.

Further, when counting the service time using a free talk classroom, it is possible to add a weighted fee according to the number of students in the free talk classroom.

Thereby, it is possible to bill a reasonable fee according to the situation.

In the above embodiments, the instructor terminal is illustrated as comprised in the device of providing education services, but the present invention is not limited to the embodiment. It is possible to use a terminal connected to a communication line. Therefore, the instructors has no necessity to be in a place where a device of providing education services are established and can connect to the system from any place in the world via Internet to have a high degree of freedom to offer a service.

In addition, a student terminal used by a member is illustrated as using a computer having an interface function of a TV camera and a microphone and an Internet connecting function, but it is possible to utilize any computer as long as it can connect to a communication line and is provided with an interface function of a TV camera and a microphone. It is possible to employ a general purpose PC, a special purpose terminal, a mobile terminal such as PDA or game machine, etc. In future, it may be possible to promote the enlargement of user by utilizing a mobile phone provided with a TV camera or the like.

In the above embodiment, the device of providing education services is illustrated as provided with a bi-directional communication server, a content delivery server and a web server, but there is no necessity to essentially comprise a contents delivery server and a web server. It is possible to exert the effects of the present invention even without a contents delivery server and a web server. In addition, there is no necessity to be provided with each hardware of the same type and it is possible to employ any hardware as long as they have the same functions. Therefore, it is possible to install the treatment function according to the present invention on a communication control unit having the conventional multi-point connection function.

In addition, it is clearly understood that the effects of the present invention can be also exerted by providing a computer on a computer having a two-way communication function with a program of running the treatment order according to the present invention.

### INDUSRIAL APPLICABILITY

As explained above, the method of providing education services according to the present invention offers a conversational mode education service by preparing a user connection table which assigns connected users of terminals connected with communication lines, establishing a virtual classroom in student terminals used by students and instructor terminals used by instructors, and running a two-way communication by means of multimedia information including TV image and sound, comprising:

a step of generating a free talk classroom table in said user connection table, in which students can freely converse with instructors,

a step of receiving an entrance request into said free talk classroom from student terminals,

a step of registering the student terminal who has made the entrance request into the free talk classroom table, when there is a vacancy in the free talk classroom,

a step of receiving an exit request from the above registered student terminals, and

a step of deleting the student terminals who has made the exit request on the free talk classroom table,

and the present invention has effects to supplement the conversation amount which may be deficient in a general conversation and improve a practical applicability because of being free of the free talking service.

In addition, the device of providing education services according to the present invention is to run the method of providing education services according to the present invention in a computer, and has effects to supplement the conversation amount which may be deficient in a general conversation and improve a practical applicability because of being free of the free talking service.

In addition, the program according to the present invention is to run the method of providing education services according to the present invention in a computer and to constitutes a device of providing education services using the same, and thereby, has effects to supplement the conversation amount which may be deficient in a general conversation and improve a practical applicability because of being free of the free talking service.

What is claimed is:

1. Method of providing education services which offers a conversational mode education service by possessing a user connection table which appoints the connected user of a terminal connected to a communication line, establishing a virtual classroom at student terminals used by students and instructor terminals used by instructors, and executing a two-way communication by multimedia information including TV image and sound, characterized in that it comprises:
a step of generating a free talk classroom table in which students can freely converse with instructors in said user connection table,
a step of receiving an entrance request into said free talk classroom from student terminals,
a step of registering the student terminal who has submitted the entrance request for the free talk classroom table when there is a vacancy in the free talk classroom,
a step of receiving an exit request from the above registered student terminals, and
a step of deleting the student terminal who has made the exit request out of from the free talk classroom table.

2. Method of providing education services according to claim 1, wherein said step of generating a free talk classroom table includes a step of registering an instructor terminal used by an instructor who can respond to said free talk classroom for said table.

3. Method of providing education services according to claim 1 or 2, wherein said step of generating a free talk classroom table comprises a step of generating tables by objects of said free talk classroom, and
said step of receiving an entrance request comprises a step of receiving the entrance requests by objects of the free talk classroom.

4. Method of providing education services according to any one of claims 1 to 3, wherein said step of receiving an entrance request comprises a step of grouping students based on personal information of the students.

5. Method of providing education services according to any one of claims 1 to 4, wherein it further comprises:
a step of registering the student terminal who has submitted an entrance request for a vacancy notice entry in case that there is no vacancy in the free talk classroom, and
a step of notifying any one student terminal registered for the vacancy notice entry in case that a vacancy happens in the free talk classroom.

6. Method of providing education services according to any one of claims 1 to 5, wherein it further comprises:
a step of generating, in said user connection table, a waiting-room table to wait the entrance into said free talk classroom,
a step of registering the student terminal who has made the entrance request for said waiting-room table, in case that there is no vacancy in the free talk classroom,
a step of deleting any one of the student terminals registered for the waiting-room table in case that a vacancy happens in the free talk classroom, and
a step of registering said deleted student terminal for said free talk classroom table.

7. Method of providing education services according to claim 6, wherein it further comprise:
a step of delivering contents into student terminals registered for said waiting-room table.

8. Method of providing education services according to any one of claims 1 to 7, wherein it further comprises a step of delivering a bulletin board which lists the free talk classrooms in a free talk classroom table.

9. Method of providing education services according to claim 8, wherein entrance buttons are prepared in said bulletin board, and it comprises a step of registering said student terminal for said free talk classroom table when said button is selected by a student terminal.

10. Method of providing education services according to any one of claims 1 to 9, wherein it further comprises a step of collecting the time that a student terminal is registered for the user connection table for the free talk classroom to bill the service fees to a person who utilized said free talking service.

11. Device of providing education services which can run the method of providing education services according to any one of claims 1 to 10 in a computer.

12. Program for running the method of providing education services according to any one of claims 1 to 10 in a computer.
